(19) United States
(12) Patent Application Publication
(10) Pub. No.: US 2005/0111652 A1
(43) Pub. Date: May 26, 2005

(54) Call information recording

(76) Inventor: Steven J. Coule, Hampshire (GB)

Correspondence Address: BUCKLEY, MASCHOFF, TALWALKAR LLC, 5 ELM STREET, NEW CANAAN, CT, 06840, US

(21) Appl. No.: 10/723,415

(22) Filed: Nov. 26, 2003

(51) Int. Cl. H04M 3/00; H04M 5/00

(52) U.S. Cl. 379/265.02

(57) ABSTRACT

A system, an apparatus, and a method for obtaining information related to a call and formatting that information in a non-proprietary format.

### BACKGROUND

Automatic call distribution (ACD) systems generally utilize software running in servers to receive multiple calls directed to, for example, a single number, and distribute each of those calls to a proper agent to be answered by a party on one of multiple lines. ACD systems furthermore typically operate in private networks such as Private Branch Exchange (PBX) systems or Internet Protocol (IP) telephony systems. ACD systems also generally direct outgoing calls from a plurality of phones in the private network to a lesser number of lines to efficiently utilize those telephone lines.

For example, an ACD system may operate in conjunction with a Direct Inward Dialing (DID) system in which a block of numbers, for example 100 numbers are provided, each of which may be associated with a telephone or other agent, which in turn may be associated with a person or department in the company. A lesser number of telephone lines, for example 10 lines that may be referred to as trunk lines, may be provided to handle all incoming calls to and outgoing calls from the 100 agents.

ACD systems often operate in conjunction with Computer Telephony Integration (CTI) systems that utilize CTI software, usually running in servers, to manage telephone calls. CTI systems are commonly used by businesses in connection with private networks to process calls in such a way as to enhance business environments. For example, a telephone number from which an incoming telephone call originated may be used to authenticate the caller and permit access to the CTI system by confirming that the originating telephone number exists in a user database. CTI systems may, for example, be used to reroute outbound calls made by a pre-dialer to a telemarketer when a telephone call is determined to have been answered by a person or may receive and route facsimile messages to an appropriate facsimile machine. A CTI system may also incorporate such things as Interactive Voice Response (IVR) with which a caller voice pattern or command may be recognized for such things as authentication and call routing. The CTI system may furthermore manage voice and video conferencing.

### BRIEF DESCRIPTION OF THE DRAWINGS

The accompanying drawings, wherein like reference numerals are employed to designate like components, are included to provide a further understanding of automatic call distribution call information recording, are incorporated in and constitute a part of this specification, and illustrate embodiments of automatic call distribution call information recording that together with the description serve to explain the principles of automatic call distribution call information recording.

In the drawings:

FIG. 1 illustrates an embodiment of an automatic call distribution telephony device;

FIG. 2 illustrates an embodiment of a method of storing call records and call center statistics in a format that is common to various applications;

FIG. 3 illustrates an embodiment of a processor based common format call record formation device; and

FIG. 4 illustrates an embodiment of a call distribution network.

### DETAILED DESCRIPTION

Reference will now be made to embodiments of automatic call distribution (ACD) call detail recording, examples of which are illustrated in the accompanying drawings. Details, features, and advantages of ACD call detail recording will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

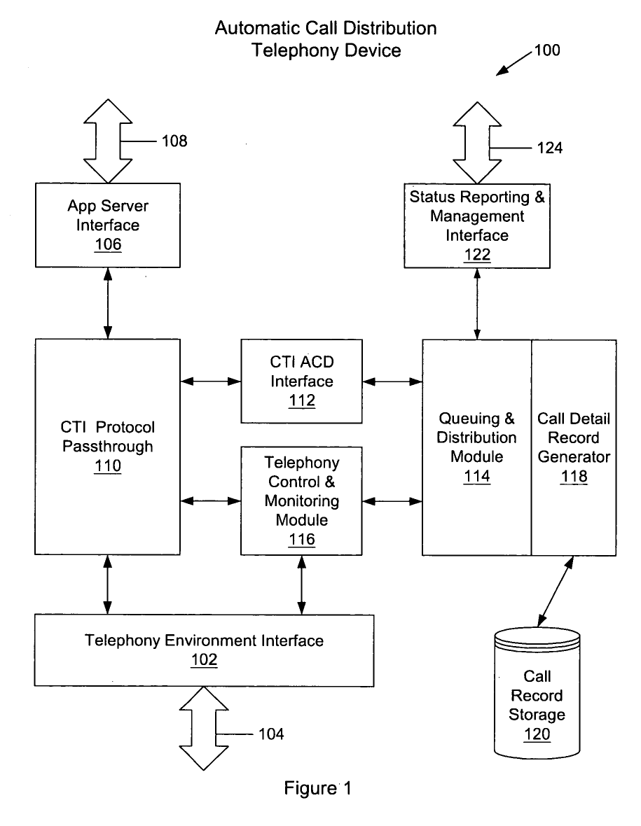

FIG. 1 illustrates an embodiment of an automatic call distribution telephony device 100 that may, for example be coupled to a telephone network at 104, an application server at 108, and a management interface at 124. The automatic call distribution telephony device 100 may provide automatic call distribution and may retain call records. The automatic call distribution telephony device 100 includes a telephony link 102 that may link a telephony environment at 104 such as a Private Branch Exchange (PBX), an Internet Protocol (IP) telephony system, or a Computer Supported Telephony Application (CSTA), to a call management system, such as a CTI system.

For illustrative purposes, embodiments will be described in connection with a CTI based system recognizing, however, that such exemplification is not intended to limit those embodiments, which could also be described and operated in connection with other call center or telephony systems.

The CTI system may, for example, operate on a private network that supports IP telephony, such as a Local Area Network (LAN) or a Wide Area Network (WAN), may operate on a private network supporting Time Division Multiplexing (TDM), and may operate as a call center providing switching functionality and information collection and integration. The information may be used, for example, to direct incoming calls or to provide pertinent information about a caller to a telephony agent, such as a telephone having a display, for use by a person receiving the call.

The CTI system may also assure that the network is not accessed or corrupted by the general public. Those private networks may interface to a public network, such as the Internet or a Public Switched Telephone Network (PSTN), through a firewall configured to provide various security functions such as filtering and address translation, to protect the private network from access or corruption by people outside of the organization that have access to the public network.

CTI systems generally have an open architecture that allows flexibility, permitting CTI systems to be easily migrated to new types of applications that work with either PSTN based systems, PBXs, or IP based systems. CTI systems are generally scalable and can share computer telephony hardware with other applications, thus offering a cost effective solution for many telephony needs.

Call centers are a typical application in which CTI systems are used. Call centers are generally central locations through which high volumes of telephone calls are directed and which can simultaneously screen, forward and log those calls. Call centers are often used by mail order organizations and telemarketing companies.

Such a CTI system may operate on a public network utilizing a protocol such as the Simple Object Access Protocol (SOAP) to provide a high level of security using CTI over a standard public network infrastructure, and may be implemented between public and private networks. SOAP is a minimalistic set of conventions for exchange of information in a decentralized, distributed environment. It is an Extensible Markup Language (XML) based protocol that is currently implemented on Hypertext Transfer Protocol (HTTP) and consists of four parts: an envelope that defines a framework for describing what is in a message and how to process it, a transport binding framework for exchanging messages using an underlying protocol, a set of encoding rules for expressing instances of application-defined data types, and a convention for representing remote procedure calls and responses. SOAP is defined by the W3C standard 1.2, which was submitted Sep. 24, 2002, and is available at www.w3.org.

XML provides a flexible way to create common information formats, formats that are common to a wide variety of applications, and share both the format and the data on a public or private network. As such, any user of a network may collect XML formatted data from various nodes on the network and search and compare that data in a consistent way. XML version 1.0 is a second edition of XML that was recommended on Oct. 6, 2000 and is available from www.w3.org.

HTTP is an application level protocol that includes a set of rules for transferring files of information, such as text, graphic images, sound, and video, on the World Wide Web. HTTP version 1.1 is available at ftp.isi.edu, and is identified as request for comment 2616. XML formatted information may be easily converted to HTML and then may be viewed and manipulated by use of a browser application.

SOAP defines an RPC mechanism for XML formatted messages that can be sent using the HTTP protocol. SOAP messages may be used to transmit CTI RPCs containing CTI information on both public and private networks.

TDM may be used to transmit analog information such as telephone conversations as a digital signal. For example, analog information may be sent from a source agent or node to a telephone company and be digitized at the telephone company. The digitized analog information may be transmitted, for example, from the telephone company to another telephone company, and then converted back to an analog format prior to delivery to a destination agent or node. Information in TDM format is typically transmitted over a synchronous network.

The telephony link 102, thus is a device through which telephone based information may be passed from the automatic call distribution telephony device 100 to the telephony environment and from the telephony environment to the automatic call distribution telephony device 100 and call information may be formatted in a common format using, for example, XML.

An application server interface 106 may be utilized to couple the automatic call distribution telephony device 100 to one or more application servers where desired. The application servers may, for example, determine routing of incoming and outgoing calls received at the automatic call distribution telephony device 100. The application server interface 106 may, for example, be a CTI based interface and may, when coupled to a CSTA telephony system for example, decode CSTA ASN.1 message streams into easy to use function calls. Services for Computer Supported Telecommunications Applications (CSTA) Phase III, 5^{th} edition may be found at http://www.ecma-international.org/, and was published in December 2002.

A CTI protocol passthrough 110 may filter call control commands used, for example, in CSTA and may direct ACD commands such as agent state change requests to the CTI ACD interface 112. The CTI protocol passthrough 110 may also direct non-ACD commands such as basic call control functions including make-call and hang-up, to lower protocol layers.

The CTI ACD interface 112 may manage agent state change requests and validate agents logging into stations on a switch. For example, a database of agents may be retained by or accessed by the CTI ACD interface 112 identifying agents and the stations to which they are permitted access. Requests for agent access may then be validated and permitted or invalidated and not permitted by the CTI ACD interface 112 based on the database, thereby controlling access to stations. Agent state change events generated by a queuing and distribution module 114 may also be passed through the CTI ACD interface 112 to the CTI Protocol Passthrough 110.

A telephony control and monitoring module 116 may parse call events from a phone system such as, for example, a CSTA system coupled to, for example, a PBX or a SCTA IP gatekeeper. The telephony control and monitoring module 116 may communicate with the queuing and distribution module 114 regarding any call events under control of the telephony control and monitoring module 116. Call events may also be routed to a CTI application server at 108 through the CTI protocol passthrough 110 and the application server interface 106.

The queuing and distribution module 114 may queue calls and distribute them to appropriate agents. For example, all calls arriving at a call center may be queued and allocated to virtual agents on a first received, first served basis. The queuing and distribution module 114 may support multiple such queues, identify calls from, for example, premier customers or other callers to be given higher priority, and route those high priority calls to queues with short waiting times. The automatic call distribution telephony device 100 may not implement advanced call management, but may rather provide appropriate queuing to an application server that controls the call center through the application server interface 106.

A status reporting and management interface 122 may be coupled to the queuing and distribution module 114 and may interface to a management console, such as a console operating in accordance with Enterprise Computer Telephony Forum (ECTF) standard R.100, at 124. The status reporting and management interface 122 may, for example, access call records and manipulate the information contained therein to provide reports that may be useful to management in, for example, determining staffing levels required on various days and at various times of day to match call levels experienced.

ECTF R.100 standardizes data collection for call centers using open application programming interfaces to define how to derive data from both circuit- and packet-switched voice calls. The ECTF standard, including the R.100 standard, may be found at http://www.ectf.org/.

A call detail record generator 118 may gather information related to the distribution of calls and information about calls that enter the automatic call distribution telephony device 100 and derive statistical information therefrom. The call detail record generator 118 may be driven by the queuing and distribution module 114 in that the call detail record generator 118 may monitor the performance of the queuing and distribution module 114 and provide statistics and information on call center performance to a call center manager. The call detail record generator 118 may create a record for each individual call and may periodically generate a record related to statistical information related to one or more of a wide variety of metrics such as call waiting times and the rate of incoming calls that are abandoned prior to being answered. The data types recorded by the call detail record generator 118 may be as specified in specification R.100 of the ECTF specification relating to call center reporting but may be formatted in a format that is common to various applications such as, for example, XML.

The commonly formatted information may then be stored in a call record storage device 120. The records and statistics generated by the call detail record generator 118 may be stored in the call record storage device 120 according to specification R.100 of the ECTF Specification as well, but in XML format. Because XML provides a rigid data structure, the records may be read from the call record storage device 120 and converted into HTML for display using a standard web browser, or converted into another desired format, such as a desired database record format.

It should be recognized that storing information in XML format is one example, and that other formats may be used, but the wide acceptance of interchangeability between XML and various applications makes XML a format that is useful.

Statistics related to call distribution may include, for example, average number of calls in a queue during a time period, average amount of time that calls waited in a queue during a time period, or how long an average call was held at each step from a queue to an agent or a second agent, where applicable.

Information related to calls may include, for example, information related to the agent or party placing the call to the agent, information related to a party to whom the call is directed, how long each call was held in a waiting queue, whether the call was answered by an agent or terminated prior to receipt by an agent, and the length of time each individual call was held at each step from a queue to an agent or later agent, where applicable.

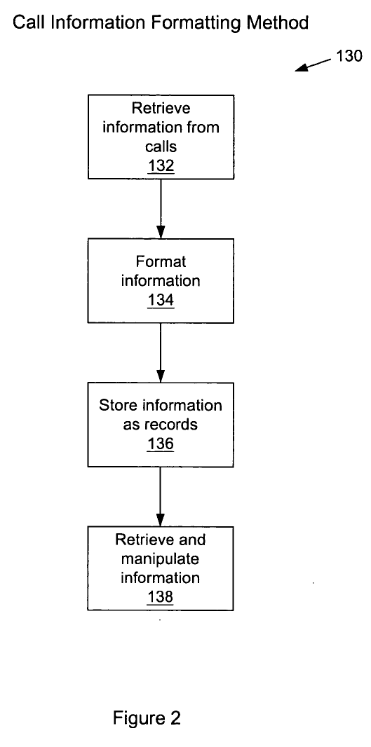

FIG. 2 illustrates an embodiment of a method of storing call records and call center statistics in a format that is common to various applications 130. At 132, call information is retrieved from one or more calls that may have been received at or transmitted from a call center. That information is formatted in a non-application specific way so that various applications may access and use the formatted information at 134. The formatting may, for example, be in XML format in which fields in records are tagged, thereby also providing a simple to use and powerful search facility. At 136, the commonly formatted call information is stored as one or more records in a database and at 138 the information may be retrieved from the database and manipulated by an application to generate useful reports or the like.

An embodiment of an article of manufacture may include a computer readable medium having stored thereon instructions which, when executed by a processor, cause the processor to format information related to a call in a non-proprietary format. In an embodiment, the computer readable medium may also include instructions that cause the processor to retrieve call information and store the commonly formatted call information.

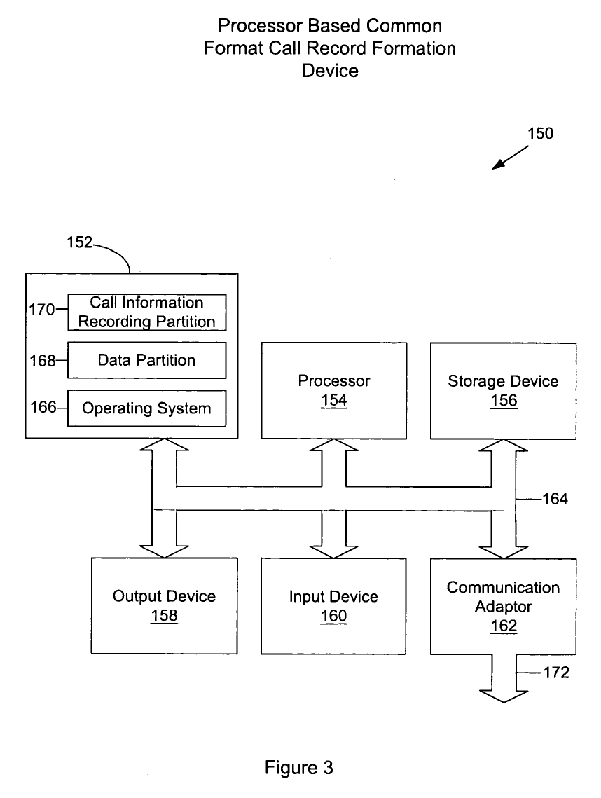

FIG. 3 illustrates an embodiment of a processor based common format call record formation device 150. The processor based common format call record formation device 150 includes memory 152, a processor 154, a storage device 156, an output device 158, an input device 160, and a communication adaptor 162. It should be recognized that any or all of the components 152-162 of the processor based common format call record formation device 150 may be implemented in a single component. For example, the memory 152 and processor 154 might be combined in a state machine or other hardware based logic machine. It should be recognized that the processor based common format call record formation device 150 may have fewer components or more components than shown in FIG. 3. For example, if output devices 158 or input devices 160 are not desired, they may not be included with the processor based common format call record formation device 150.

Communication between the processor 154, the storage device 156, the output device 158, the input device 160, and the communication adaptor 162 may be accomplished by way of one or more communication busses 164. Those busses 164 may include, for example, a system bus, a peripheral component interface bus, and an industry standard architecture bus.

The memory 152 may, for example, include random access memory (RAM), dynamic RAM, and/or read only memory (ROM) (e.g., programmable ROM, erasable programmable ROM, or electronically erasable programmable ROM) and may store computer program instructions and information. The memory 152 may furthermore be partitioned into sections including an operating system partition 166 wherein instructions may be stored, a data partition 168 in which data may be stored including call records arranged in a common format, and a call information recording partition 170 in which instructions for distribution of calls and recording information about calls may be stored. The processor based common format call record formation device 150 may also allow execution by the processor 154 of the instructions stored in the call information recording partition 170.

The processor 154 may execute the program instructions and process the data stored in the memory 152. In one embodiment, the instructions are stored in memory 152 in a compressed and/or encrypted format. As used herein the phrase, “executed by a processor” is intended to encompass instructions stored in a compressed and/or encrypted format, as well as instructions that may be compiled or installed by an installer before being executed by the processor 154.

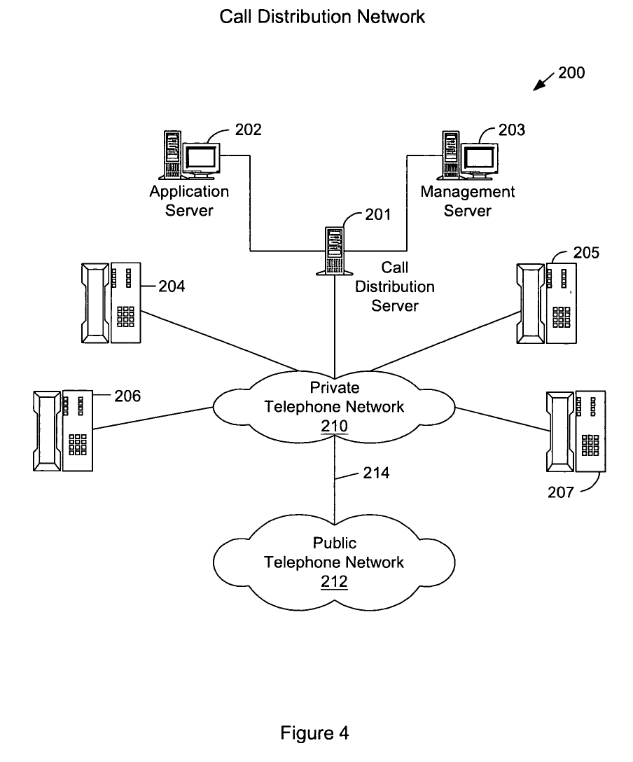

The storage device 156 may, for example, be a magnetic disk (e.g., floppy disk and hard drive), optical disk (e.g., CD-ROM) or any other device or signal that can store digital information. The communication adaptor 162 may permit communication between the processor based automatic call distribution telephony device 150 and other devices or nodes coupled to the communication adaptor 162 at a communication adaptor port 172. The communication adaptor 162 may be a network interface that transfers information from nodes on a network such as the network 200 illustrated in FIG. 4, to the processor based common format call record formation device 150 or from the processor based common format call record formation device 150 to nodes on the network 200. The network in which the processor based common format call record formation device 150 operates may be a PBX, PSTN, LAN, WAN, the Internet or another network or combination of such networks. It will be recognized that the processor based common format call record formation device 150 may alternately or in addition be coupled directly to one or more other devices through one or more input/output adaptors (not shown).

The processor based common format call record formation device 150 may be coupled to one or more output devices 158 such as, for example, a monitor or printer, and one or more input devices 160 such as, for example, a keyboard or mouse. It will be recognized, however, that the processor based common format call record formation device 150 does not necessarily need to have any or all of those output devices 158 or input devices 160 to operate.

FIG. 4 illustrates an embodiment of a call distribution network 200 in which embodiments of call information recording may be implemented. In that embodiment, a call distribution server 201, which may be the automatic call distribution telephony device 100 described in connection with FIG. 1, is coupled to a private network 210 that may be, for example, an IP telephony LAN or a PBX. The call distribution server 201 is also coupled to an application server 202 and a management server 203 that may operate, for example, as described in connection with FIG. 1.

One or more agents 204-207, such as telephones, may also be coupled to the private telephone network 210. Incoming calls may be directed to those agents 204-207 through the call distribution server 201 and outgoing calls from those agents 204-207 may be directed out to a public network 212 on one or more trunk lines 214 by the call distribution server 201

The call distribution network 200 may be a network of nodes such as telephones, voice over IP telephones, computers, servers, or other, typically processor-based, devices interconnected by one or more forms of communication media. The communication media coupling those devices may include, for example, twisted pair wiring, co-axial cable, optical fibers and wireless communication methods such as use of radio frequencies.

Network nodes may be equipped with the appropriate hardware, software, or firmware necessary to communicate information in accordance with one or more protocols. A protocol may comprise a set of instructions by which the information is communicated over the communications medium. Protocols are, furthermore, often layered over one another to form something called a “protocol stack.” In one embodiment, the network nodes operate in accordance with a packet switching protocol referred to as the User Datagram Protocol (UDP) as defined by the Internet Engineering Task Force (IETF) standard 6, Request For Comment (RFC) 768, adopted in August, 1980 (“UDP Specification”), and the Internet Protocol (IP) as defined by the IETF standard 5, RFC 791 (“IP Specification”), adopted in September, 1981, both available from “www.ietf.org.” In another embodiment, Transmission Control Protocol (TCP) as defined by the Internet Engineering Task Force (IETF) standard 7, Request For Comment (RFC) 793, adopted in September 1981, (“TCP Specification”) may be used with IP. Stream Control Transmission Protocol (SCTP) may also be utilized in connection with an embodiment. SCTP is defined by IETF RFC 2960, published in October 2000.

Nodes may operate as source nodes, destination nodes, intermediate nodes or a combination of those source nodes, destination nodes, or intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include signaling messages.

While the systems, apparatuses, and methods of common format call record formation have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

1. A method of formatting call information, comprising:
obtaining information related to a call; and
formatting that call information in a non-proprietary format common to various applications.

2. The method of claim 1, further comprising storing the formatted call information.

3. The method of claim 2, further comprising searching the formatted call information.

4. The method of claim 1, wherein the calls are transmitted from a call center.

5. The method of claim 1, wherein the calls are received at a call center.

6. The method of claim 1, further comprising:
obtaining information related to a plurality of calls;
formatting the call information related to the plurality of calls in a non-proprietary format; and
generating call records from the formatted information related to the plurality of calls.

7. The method of claim 1, wherein the non-proprietary format is XML.

8. The method of claim 1, wherein the call is an internet protocol telephony call.

9. The method of claim 1, wherein the call is a time division multiplexed call.

10. The method of claim 1, further comprising identifying agents accessing a call distribution telephony device.

11. The method of claim 10, further comprising validating access to the call distribution telephony device.

12. The method of claim 1, further comprising queuing a plurality of calls received and distributing the plurality of calls to a plurality of agents in a first received first served basis.

13. The method of claim 1, wherein the information is formatted in accordance with an enterprise computer telephony forum standard.

14. The method of claim 1, wherein the formatted call information is manipulated by an application to determine numbers of calls received at various times of day.

15. The method of claim 1, wherein the information is manipulated by an application to determine amounts of time that calls remain in certain states.

16. The method of claim 1, wherein the information includes information related to distribution of the call.

17. The method of claim 1, wherein the information includes information related to a party placing the call.

18. The method of claim 1, wherein the information includes information related to a party to whom the call is directed.

19. A call distribution telephony device, comprising:
a processor coupled to the telephone network interface to obtain and format call information into a non-proprietary format; and
a storage device coupled to the processor to store the formatted call information.

20. The call distribution telephony device of claim 19, further comprising an application server interface coupled to the processor and an application server, the application server to determine routing of calls.

21. The call distribution telephony device of claim 20, wherein the application server is further to retrieve the call information from the storage device and manipulate the call information.

22. The call distribution telephony device of claim 19, wherein the storage device includes a database in which the call information is stored.

23. A computer telephony integration device, comprising:
a telephone network interface to couple to a telephone network;
a processor coupled to the telephone network interface to obtain and format call information into a non-proprietary format; and
a storage device coupled to the processor to store the formatted call information.

24. The computer telephony integration device of claim 23, wherein the processor is further to determine routing of calls received from the telephone network.

25. The computer telephony integration device of claim 23, wherein the processor is further to determine routing of calls transmitted to the telephone network.

26. The computer telephony integration device of claim 23, wherein the storage device includes a database in which the call information is stored.

27. An article of manufacture, comprising:
a computer readable medium having stored thereon instructions which, when executed by a processor, cause the processor to format information related to a call in a non-proprietary format.

28. The article of manufacture of claim 27, wherein the instructions further cause the processor to store the formatted call information in a data storage device.

29. The article of manufacture of claim 27, wherein the instructions further cause the processor to create statistical information in a non-proprietary format from information related to a plurality of calls.

30. The article of manufacture of claim 27, wherein the instructions further cause the processor to retrieve the information related to the call from a received call.
